(19) United States
(12) Patent Application Publication
(10) Pub. No.: US 2005/0121495 A1
(43) Pub. Date: Jun. 9, 2005

(54) Temperature control system for solder handling devices and method for temperature control for those devices

(76) Inventor: Tetuo Yokoyama, Hannan-shi (JP)

Correspondence Address: Squire, Sanders & Dempsey L.L.P.;14th Floor, 801 S. Figueroa Street, Los Angeles, CA, 90017-5554, US

(21) Appl. No.: 10/859,936

(22) Filed: Jun. 2, 2004

(30) Foreign Application Priority Data
Dec. 9, 2003 (JP) 2003-409868(PAT)

(51) Int. Cl. B23K 37/00

(52) U.S. Cl. 228/9

(57) ABSTRACT

In a temperature control system for controlling a heating member or means of a solder handling device, a plurality of solder handling devices such as soldering iron, a heater tweezer, a solder sucker and a hot air blower are selectively coupled with a temperature controller which in turn identify the solder handling device connected thereto and controls temperature of the heater of the connected device with temperature control characteristic suitable for the device. Each solder handling device may have a resistor of which resistance value represents the type of the device so that the temperature controller identify the device by the resistance value.

### CROSS-REFERENCE TO RELATED APPLICATIONS

This application is based on a Japanese patent application serial No. 2003-409868, filed with the Japan Patent Office on Dec. 9, 2003, the contents of which are hereby incorporated by reference.

### BACKGROUND OF THE INVENTION

1. Field of the Invention

The present invention relates to a temperature control system for solder handling devices such as a soldering iron, a tweezer type heater (referred to as a heater tweezer hereinafter), a solder sucker, and a hot air blower, and also relates to a method for temperature control for those devices. More particularly, the present invention pertains to such a temperature control system or method for a plurality of solder handling devices which are selectively connected with a temperature controller for the temperature control.

2. General Background and State of the Art

Various types of solder handling devices have been used for soldering and other solder handling procedures in relation to electric and electronic parts and substrates on which the parts are mounted by solder. Such solder handling devices may include a soldering iron, a heater tweezer for clamping an electric or electronic part therebetween and reflowing solder for installation and removal of the part, a solder sucker for reflowing and sucking solder on the substrate, and a hot air blower or gun for blowing hot air against the parts or substrate to reflow and blow away solder. Each of the solder handling devices is provided with a heater for heating a heating member or medium such as a tip of the soldering iron, tips of the tweezer heater, a nozzle of the solder sucker, and the air to be blown out of the blower. Those solder handling devices may be provided with a temperature controller for the control of electric power to be supplied to the heater such that the heating member or medium is heated to a desired target temperature.

For such temperature control, a high level of temperature restoring characteristics is required to raise the temperature of the heating member or medium rapidly and smoothly to a target value and stably maintain the target temperature. For such high level of temperature restoring characteristic, a feedback control is suitable which detects current or instantaneous actual temperature of the heating member or medium and supplies the appropriate amount of electric power to the heater in accordance with the detected temperature. A proportional control (P control) and a proportional integral and differential control (PID control) are generally employed for such feedback control.

It is important for the temperature control that the difference between a set or target temperature intended by a user and the actual temperature of the heating member or medium during use is converged to a small valve. In other words, it is important that the actual temperature is measured with high accuracy so that a compensation may be made to the measured value. A Japanese unexamined patent publication No. 11-10328 discloses a soldering iron device in which the temperature measurement is made with high accuracy by first detecting the difference between a set temperature and an actual temperature measured by an external temperature measuring device, and then making a temperature compensation in accordance with the detected difference.

It is also favorable that some safeguard is provided to prevent the user from setting a temperature for the heating member or medium that deviates from a standard temperature range. A device is known which has a predetermined limit for the temperature to be set for the heating member or medium and which invalidates the setting of a temperature beyond the limit. A Japanese examined patent publication No. 7-90363 discloses a temperature controllable soldering iron having a handle in which a key including a resistor for finally determining a set or target temperature is interchangeably installed. The latter soldering iron requires that another key having a resistor of different resistance value corresponding to a newly set temperature is installed for changing the set temperature. Accordingly, only a proper person such as a foreperson having such a key can change the set or target temperature.

In general, the solder handling device which is to be held by a user for the solder handling and a temperature controller which serves as the power supply and temperature control device for the solder handling device, are separated from each other for easiness of handling and are connected to each other by an electric cord. The solder handling device varies with its intended use, such as soldering, removal and installation of parts, sucking of solder and blowing away of solder, while the temperature controller is substantially the same in its functions for any of these types of solder handling device. In view of this, a solder-handling-device-interchangeable system is known in which a temperature controller is commonly used for a plurality of types of solder handling devices. In such a system, solder handing devices are selectively connected with the common temperature controller through connectors provided between the solder handling devices and the temperature controller.

However, the known solder-handling-device-interchangeable system has a problem that the temperature restoring characteristic is inferior for some type of solder handling devices. For example, the temperature rises to a set temperature rapidly and smoothly when a particular solder handling device is connected to the temperature controller, while the temperature rises so rapidly as to cause overshoot wherein the actual temperature goes beyond desired or target temperature, when another type of solder handling device is connected to the temperature controller. In other case, the actual temperature rises so slowly for certain types of solder handling device that it takes too much time for the temperature controller to restore the set value.

The known system has another problem in that the accuracy of temperature measurement is inferior for a certain type of solder handling device. For example, highly accurate temperature measurement is available for a particular solder handling device, while the accuracy of temperature measurement is so low as to cause too much of a difference between the set temperature and the actual temperature for another type of solder handling device.

In addition, when a limit or limits are set for the setting of a target temperature in order to prevent a user from setting a target temperature that deviates largely from a standard value, the limit may be improper for some types of solder handling devices. For example, the limit may be proper for a particular type of solder handling device, but the limit is too high or too low, or a range between an upper and lower limits is too large or too small, for another type of solder handling device.

The calibration measurement taken in the above mentioned Japanese examined patent publication No. 7-90363 may cope with the problem of temperature setting. As the soldering iron of the publication is provided with a key for determining a set temperature, the target temperature is automatically changed when another solder handling device is in use, provided that each solder handling device has a key including a resistor particular to the device. However, the resistor of the key represents a pinpoint value so that the key must be frequently interchanged every time the target or desired temperature is required to be changed. In addition, a lot of keys must be provided for changing the target temperature at many intervals.

Still further, the known system is provided with a single temperature sensor for the sake of common use of the temperature controller and is adapted to supply the same amount of electric power to a pair of heaters for the two tips of a tweezer heater in accordance the output of a single sensor in one of the two tips. In that case, the temperature of one of the tips is not detected, and is likely to deviate from a desired value.

### INVENTION SUMMARY

It is a primary object of the present invention to provide a temperature control system in which a plurality of solder handling devices are selectively coupled or connected with a temperature controller and in which the temperature of a heating member or members is controlled in a manner appropriate to the coupled or connected device.

It is another object of the present invention to provide the temperature control system in which a temperature controller controls each solder handling device with a high level of temperature restoring characteristics that is appropriate to the device.

It is a further object of the present invention to provide a temperature control system in which a plurality of solder handling devices are selectively coupled or connected with a temperature controller and in which the temperature controller identifies the solder handling device connected thereto and supplies electric power to the device with the power supply being controlled in accordance with the identification.

It is still another object of the present invention to provide a temperature control system in which a plurality of solder handling devices are selectively coupled or connected with a temperature controller and in which the temperature controller identifies the solder handling device connected thereto and determines a limit or a range for setting of a target temperature in accordance with the identification.

It is yet another object of the present invention to provide a temperature control system in which a plurality of solder handling devices are selectively coupled or connected with a temperature controller and in which the temperature controller identifies the solder handling device connected thereto and detects actual temperature of a heating member or medium with high accuracy and reliability.

To attain one or more of the above-mentioned objects, a temperature control system according to the present invention comprises a temperature controller and a plurality of solder handling devices which are selectively connected with the temperature controller, and wherein each solder handling device includes a heating member or medium, a heater for heating the heating member or medium and a temperature sensor for detecting temperature of the heating member, and the temperature controller includes a device identifier for identifying the solder handling device connected thereto, a power supply for supplying electric power to the solder handling device and a power supply control for controlling the supplied power in accordance with the temperature detected by the temperature sensor and the identification of the solder handling device.

According to an aspect of an embodiment of the present invention, in a method for controlling temperature of a solder handling device in a system in which a plurality of solder handling devices are selectively connected with a temperature controller which supplies electric power and control temperature of heating member provided on the device or heating medium generated by the device, the method comprises the steps of identifying the solder handling device connected to the temperature controller, and determining temperature control characteristic to be employed for the control of the temperature of the heating member or medium, the characteristic being determined in accordance with the identified solder handling device.

According to another aspect of an embodiment of the present invention the temperature controller includes a temperature control characteristic section for determining a temperature control characteristic for each solder handling device, the power supply is controlled in accordance with the determined temperature control characteristic.

The above and other features, objects and advantages of the present invention will become more apparent from reading of the following description of a preferred embodiment with reference to the following drawings.

### BRIEF DESCRIPTION OF THE DRAWINGS

FIG. 1 is a schematic illustration of a temperature control system for a solder handling device according to an embodiment of the present invention;

FIG. 2 shows circuits of a soldering iron and its connector;

FIG. 3 shows circuits of a tweezer heater and its connector;

FIG. 4 shows circuits of a micro-tweezer heater and its connector;

FIG. 5 shows circuits of a solder sucking or absorbing device and its connector;

FIG. 6 is a block diagram showing the circuit of the temperature control system;

FIG. 7 is a diagram showing temperature control characteristics of the temperature control system;

FIG. 8 is a flow chart schematically showing operation of a temperature control section of the temperature control system;

FIG. 9 is a diagram showing change of temperature at a tip of a solder handling device; and

FIG. 10 shows a circuit for identifying a solder handling device according to another embodiment of the present invention.

### DETAILED DESCRIPTION OF THE PREFERRED EMBODIMENTS

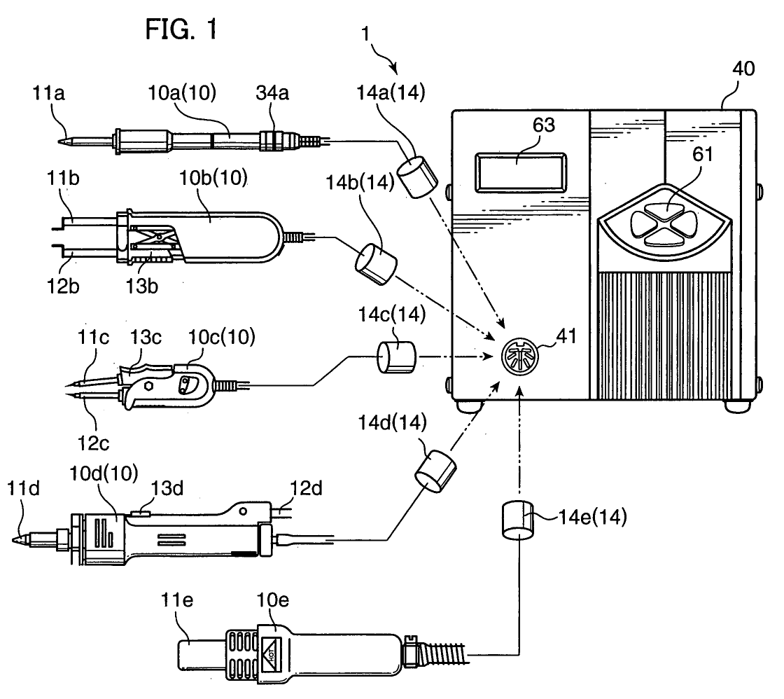

Referring to FIG. 1 showing a temperature control system 1 according to an embodiment of the present invention, the system is composed of solder handling devices 10a, 10b, 10c, 10d, and 10e and a temperature controller 40. The solder handling devices may include a soldering iron 10a, a heater tweezer 10b, a micro heater tweezer 10c, a solder sucker or absorber 10d and a hot-air gun or blower 10e which are selectively connected with the temperature controller 40 through their respective connectors 14a, 14b, 14c, 14d and 14e. Each of the solder handling devices 10a, 10b, 10c, 10d, and 10e includes a heater or heaters and a heating member or heating members, or heating medium generator such as a tip or tips or hot-air blower.

The temperature controller 40 serves to supply electric power to the heater or heaters of the solder handling device and control the temperature of the heating member or members or heating medium. A circuit for the power supply and the temperature control is incorporated in a casing of box shape. The temperature controller is provided, on its front panel, with a single connector 41 which serves as a controller connector that can be connected with any of the connectors 14a, 14b, 14c, 14d and 14e of the solder handling devices 10a, 10b, 10c, 10d, and 10e. An input member 61 is adapted to be operated by a user or operator to set a temperature of the heating member or medium and input other data which will be described later. A display 63 is adapted to display the set temperature and a current temperature of the heating member or members or medium.

When the soldering iron 10a is connected to the temperature controller 40 through the connector 14a, electric power is supplied from the temperature controller 40 to a heater of the soldering iron 10a to heat a tip 11a, and the tip 11a is maintained at a given temperature by the temperature controller 40. The soldering iron 10a may vary in its size and shape of the tip 11a and accordingly in its thermal capacity and thermal output. In that case, an identifying number may be marked on the soldering iron to identify the type of the soldering iron and/or its tip. Then, the operator should input the identifying number to the temperature controller 40 by the input member 61, and the temperature controller 40 automatically controls the temperature of the tip 11a so as to adapt the temperature control manner to the type of the soldering iron. To this end, the temperature controller 40 may set a proper target temperature for the tip 11a in accordance with the type of the soldering iron or its tip. An LED 34a is provided on the soldering iron 10a in the rear portion thereof to indicate whether the identifying number has been inputted. The LED 34a may be lit continuously when the identifying number has been inputted, while the LED 34a may be winked to urge the operator to input the identifying number when the identifying number has not been inputted.

When the heater tweezer or tweezer type heating tool 10b is connected with the temperature controller 40 through the connector 14b, the temperature controller 40 supplies electric power to the heaters of the heater tweezer 10b and heats its pair of tips 11b and 12b. The heaters are provided for respective tips 11b and 12b. The heater tweezer 10b has a pair of legs which are urged to assume the positions where they are away from each other. When a user pushes down a manipulation member 13b, one of the legs is moved toward the other leg to clamp an electric or electronic part between the tips 11b and 12b. Then, heat is applied to the electric or electronic part from the heated tips 11b and 12b to reflow solder, thereby enabling installation or removal of the electric or electronic part with respect to a substrate such as a circuit board. An example of such tweezer heater 10b is disclosed in a U.S. patent application Ser. No. 10/224,272 which has been assigned to the co-assignee of the present application, and its disclosure is incorporated herein by the reference. The temperatures of the tips 11b and 12b are controlled by the temperature controller 40 to be maintained at values which are proper or appropriate for the tweezer heater 10b.

The micro heater tweezer 10c may be connected with the temperature controller 40 through the connector 14c such that electric power is supplied to the heaters of the micro tweezer heater 10c for heating a pair of tips 11c and 12c with the temperatures of the tips 11c and 12c being controlled by the controller 40. The heaters are provided for respective tips 11c and 12c. The micro tweezer heater 10c has substantially the same structure as that of the tweezer heater 10b but is small in size so that it is adapted for operation in narrow positions and/or for manipulation or handling of smaller electric and electronic parts. The micro tweezer heater 10 is provided with a manipulation member 13c which is operated by a user to open and close its legs to clamp the electric or electronic part therebetween and reflow its solder for installation and removal of the part with respect to a substrate.

When a solder sucker 10d is connected through the connector 14d to the temperature controller 40, electric power is supplied to the heater of the solder sucker 10d which, in turn, heats nozzle portion 11d of the solder sucker 10d to reflow solder attached to an electric or electronic part or a substrate when the nozzle portion 11d is brought into contact with or make close to the solder. The solder sucker 10d is formed with a through-hole from the nozzle to a reservoir or tank provided within the sucker 10d and communicated with a vacuum pump (not shown) through an outlet 12d such that the reflowed solder is sucked by negative pressure of the vacuum pump. The sucked solder is temporarily reserved in the reservoir which exchanged with other empty reservoir when it becomes full. The solder sucker 10c is provided with a trigger 13d which is to be operated by a user to turn on a trigger switch for actuating the vacuum pump. The temperature controller 40 controls the temperature of the nozzle 11d to maintain the temperature at a value suitable for the solder sucking.

The hot air blower or gun 10e includes a heater for heating air supplied from an external blower or fan (not shown). The heated hot air is blown against the solder on an electric or electronic part or substrate through the nozzle to reflow the solder. The hot air serves as heating medium heated by the heater and heating the solder. The hot air blower 10e may be connected with the temperature controller 40 through a connector 14e such that the temperature of the hot air is controlled to be maintained at a value suitable for the hot air to be blown against the solder.

As described above, the controller connector 41 of the temperature controller is adapted to be connected with any of the connectors 14a, 14b, 14c, 14d and 14e so that the temperature controller 40 can control any of the solder handling devices 10a, 10b, 10c, 10d and 10e in the manner suitable for each of the solder handling devices 10a, 10b, 10c, 10d and 10e. To this end, the temperature controller 40 is adapted to identify the solder handling device connected thereto. Description will be made in more detail in the following with respect to circuits for identifying the solder handling device.

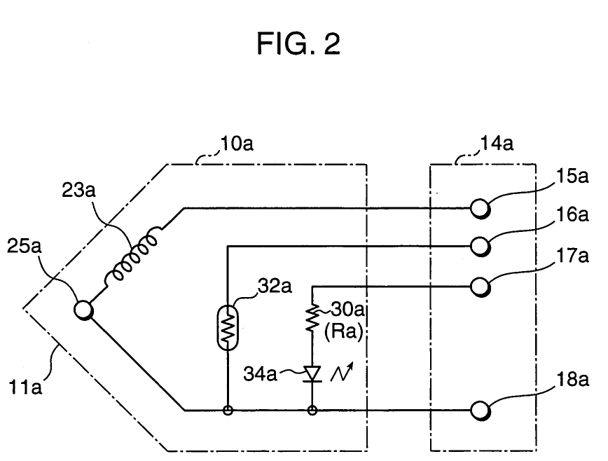

FIG. 2 is a circuit diagram showing circuits of the soldering iron 10a and the connector 14a. The connector 14a includes a heater terminal 15a, thermistor terminal 16a, a device identification terminal 17a and a ground terminal 18a as effective terminals. The soldering iron 10a includes a heater 23a, a temperature sensor 25a of a thermocouple, a thermistor 32a, LED 34a and a device identifying resistor 30a.

The heater 23a and the temperature sensor 25a are connected in series between the heater terminal 15a and the ground terminal 18a. The heater 23a is provide within the tip 11a to heat the tip 11a. The temperature sensor 25a is located within or close to the tip 11a to detect the temperature of the tip 11a. The thermistor 32a is connected between the thermistor terminal 16a and the ground terminal 18a. The thermistor 32a is located within the soldering iron 10a at a base portion or close to the connector thereof to detect a temperature at that location for compensation for the controlled temperature of the tip 11a. The LED 34a and the device identifying resistor 30a are connected in series between the device identification terminal 17a and the ground terminal 18a. The LED 34a is lit continuously when the soldering iron identifying number or code has been inputted, and it is winked or blinks when the soldering iron identifying number or code has not been inputted.

The device identifying resistor 30a has a resistance value Ra that is specific to the soldering iron 10a. Each solder handling device 10 is provided with an identifying resistor having a resistance value that is specific to that solder handling device. In other words, the solder handling devices 10a, 10b, 10c, 10d and 10e are respectively provided with resistors of different values of resistance which respectively represent the solder handling devices 10a, 10b, 10c, 10d and 10e, with the values of resistance respectively corresponding to the solder handling devices. Thus, a device identifying circuit of the temperature controller 40 can identify the solder handling device by the resistance value.

As the device identifying resistor 30a and LED 34a are connected to the common terminals 17a and 18a, the number of terminals is saved to simplify the circuit. The serial connection of the heater 23a and the temperature sensor 25a also contribute to the saving of the number of terminal and simplification of the circuit. In the latter case, the heater 23a and the temperature sensor 25a are alternatively actuated by time sharing. The heater 23a is energized intermittently or at intervals, and the output of the temperature sensor 25a is read by the temperature controller 40 while electric power is not supplied to the heater 23a.

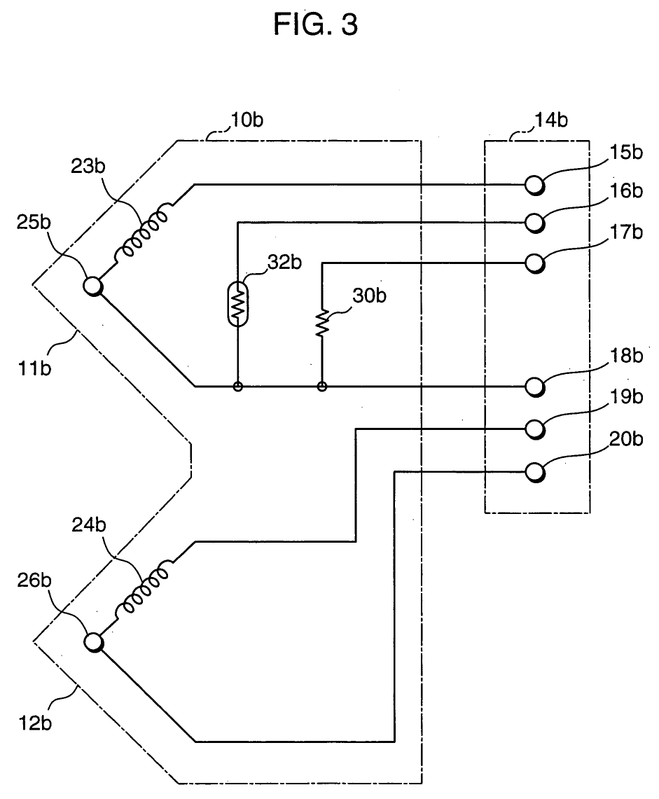

FIG. 3 is a circuit diagram of the heater tweezer 10b and the connector 14b. The connector 14b includes a first heater terminal 15b, a thermistor terminal 16b, a device identification terminal 17b, a first ground terminal 18b, a second heater terminal 19b, and a second ground terminal 20b, as effective terminals. The heater tweezer 10b includes a first heater 23b, a first temperature sensor 25b of a thermocouple, a thermister 32b, a device identifying resistor 30b, a second heater 24b and a second temperature sensor 26b of a thermocouple.

The first heater 23b, the first temperature sensors 25b, the thermister 32b and the device identifying resistor 30b have the same structures and functions as those of corresponding components of the soldering iron 10a, i.e. the heater 23a, the temperature sensor 25a, the thermistor 32a, and a device identifying resistor 30a. In other words, the circuit for the first tip 11b of the heater tweezer 10b is substantially same as the circuit for the soldering iron 10a. The device identifying resistor 30b has a specific resistance value Rb which is different from that of the device identifying resistor 30a and which is specific to the heater tweezer 10b. Accordingly, the temperature controller 40 identifies the heater tweezer 10b by that resistance value.

The heater tweezer 10b is provided with a circuit for the second heater 24b and the second temperature sensor 26b in addition to the circuit for the first tip 11b. In other words, the heater tweezer 10b is provided with a pair of combinations of the heater and temperature sensor, which combinations are respectively installed in the tips 11b and 12b such that the temperatures of the tips 11b and 12b are controlled independently of each other. Thus, if temperature of one e.g. 12b of the tips drops suddenly, temperature sensor 26b for the tip detects the temperature drop and the temperature controller 40 increases power supply to the heater 24b for the tip to restore the temperature of the tip 12b rapidly. The controller connector 41 of the temperature controller 40 is adapted to be connected with the six terminals of connector 14b. Identifying the resistance value of the device identifying resistor 30b, the temperature controller 40 knows that the heater tweezer 10b is connected thereto, and the temperature controller 40 treats the second heater terminal 19b and the second ground terminal 20b as effective terminals for the temperature control.

The micro heater tweezer 10c has substantially the same construction and functions as those of the heater tweezer 10b. The resistance value of its device identifying resistor is different from that of any other solder handling devices and is specific to the micro heater tweezer 10c such that the temperature controller 40 know that the micro heater tweezer 10c is connected thereto.

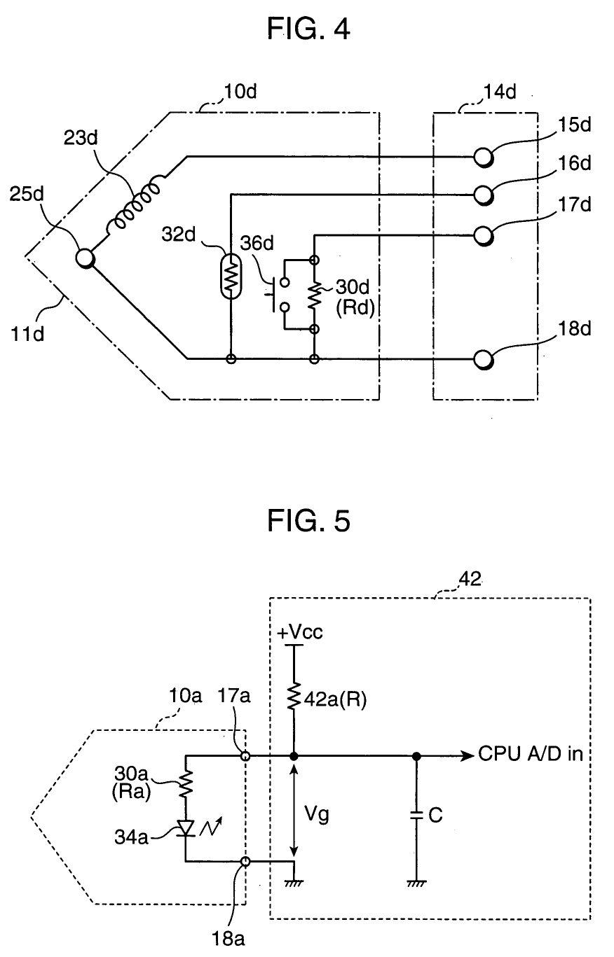

FIG. 4 is a circuit diagram of a circuit for the solder sucker 10d and a circuit of its connector 14d. The connector 14d includes four effective terminals of a heater terminal 15d, thermistor terminal 16d, a device identification terminal 17d and a ground terminal 18d. Accordingly the terminals of the connector 14d of the solder sucker 10d correspond to that of the connector 14a of the soldering iron 10a. The solder sucker 10d includes a heater 23d, a temperature sensor 25d of a thermocouple, a thermistor 32d, a device identifying resistor 30d and a trigger switch 30d.

The heater 23d, the temperature sensor 25d of a thermocouple, the thermistor 32d and the device identifying resistor 30d have the same structures and functions as those of corresponding components of the soldering iron 10a, i.e. the heater 23a, the temperature sensor 25a, the thermistor 32a, and a device identifying resistor 30a. The device identifying resistor 30d has a specific resistance value Rd which is different from that of any other device identifying resistors and which is specific to the solder sucker 10d. Accordingly, the temperature controller 40 identifies the solder sucker 10d by that resistance value.

When a user operates the trigger 13d, the trigger switch 36d is turned on to actuate the vacuum pump (not shown) and suck reflowed solder through the nozzle 11d.

The trigger switch 36d is connected across the device identifying resistor 30d. Accordingly, the resistance value of the device identifying resistor 30d is identified while the trigger switch 36d is open. As the device identifying resistor 30d and the trigger switch 36d are connected in parallel with each other between the a device identification terminal 17d and a ground terminal 18d, the a device identification terminal 17d can be used as a trigger signal detecting terminal, thereby saving the number of the terminals and simplifying the circuit construction.

The circuit for the hot air blower 10e and its connector 14e is substantially the same as that of the soldering iron 10a, but the LED 34a may be dispensed with. The hot air blower 10e is provided with a device identifying resistor 30e of a specific resistance value Re that is different from that of any other device identifying resistors and which is specific to the hot air blower 10e. Accordingly, the temperature controller 40 identifies the hot air blower 10e by that resistance value.

FIG. 5 shows a device identifying circuit 42 provided in the temperature controller 40. The device identifying circuit 42 may be selectively connected with any device identifying resistor. In the case shown in FIG. 5, the device identifying circuit 42 is connected with the resistor 30a of the soldering iron 10a. The device identifying circuit 42 shown in FIG. 5 employs constant voltage type detection.

With reference to FIG. 5, a resistor 42a is connected in series with the device identifying resistor 30a, and a constant voltage Vcc is applied across the series connection of the resistors 42a and 30a. With this connection, the voltage Vg between the device identifying terminal 17a and ground terminal 18a is shown by the following formula (1). It is to be noted here that the resistance of the LED is out of consideration for the sake of simplicity of consideration, since the resistance of the LED is not substantial.
Vg=(Ra/(Ra+R))×Vcc (1)

Wherein Vcc is a power source voltage, and R is a resistance value of the fixed resistor 42a connected between the device identifying terminal 17a and a voltage source.

As the resistance value Ra of the device identifying resistor 30a is a fixed value specific to the soldering iron 10a, the voltage Vg derived from the formula (1) has also a fixed value specific to the soldering iron 10a. Detecting that voltage Vg by its CPU, the temperature controller 40 determines that the soldering iron 10a is connected to the temperature controller 40.

By way of an example, let's assume that Ra=220Ω, R=390Ω, and Vcc=5V, then, Vg=1.80V from the formula (1). In the case when a tweezer 10b having a device identifying resistor Rb of 820Ω is connected to the controller 40, the output voltage Vg of about 3.39V will be obtained by substituting the value of Rb in place of Ra in the formula (1). Accordingly, when the temperature controller 40 detects the voltage Vg of 1.80V, it determines that it is connected with a soldering iron but not with the tweezer.

The device identifying resistor may not be provided in every solder handling device. For example, if the resistor 30d is dispensed with in the circuit of solder sucker 10d (see FIG. 4), a zero voltage appears between the device identifying terminal 17d and the ground terminal 18d when the trigger switch 36d is turned on, since it is assumed that Rd=∞ at that time. Accordingly, the temperature controller identifies the solder sucker by the zero voltage. If the resistor 30a is dispensed with in the circuit of the soldering iron 10a (see FIG. 2), then it can be regarded that a resistor of infinite resistance is connected between the device identifying terminal 17a and the ground terminal 18d, and a voltage Vcc will appear between the terminals.

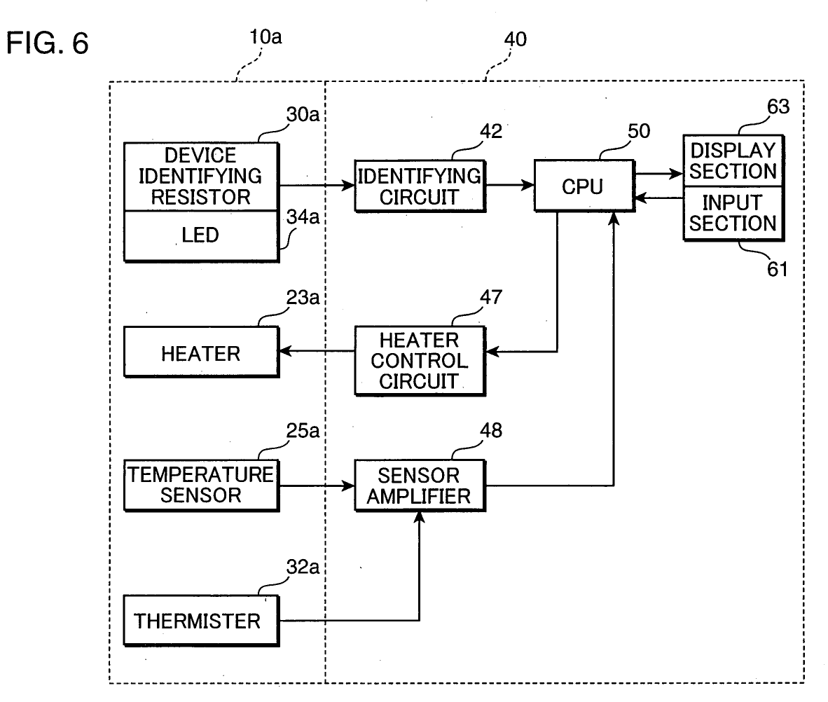

FIG. 6 is a block diagram schematically showing the control system for the solder handing device. FIG. 6 shows the case where a soldering iron 1a is coupled with the temperature controller 40, which includes an identifying circuit 42, a heater control circuit 47, a sensor amplifier 48, a CPU 50, an input section 61 and a display section 63. The heater control circuit 47 supplies electric power to the heater 23a in response to instruction from the CPU 50. Receiving signals from the temperature sensor 25a and thermister 32a, the sensor amplifier 48 amplifies those signals and sends them to the CPU 50.

The CPU 50 is a main control section of the temperature controller 40, and serves to identify the solder handling device 10 coupled thereto, by reading or detecting the device identifying voltage Vg, and controls the solder handling device 10 in accordance with that identification. When the soldering iron 10a, for example, is connected to the temperature controller 40, the CPU 50 controls the soldering iron 10a using a controlling program and control parameters that are appropriate to the soldering iron 10a.

In more detail, a set temperature set by the user is controlled by the CPU 50 such that the set temperature is within a range that is predetermined for each solder handling device, with the data of the range being stored in the CPU 50. For example, the range is from 200° C. (lower limit) to 450° C. (upper limit) for the soldering iron 10a, from 200° C. (lower limit) to 400° C. (upper limit) for the heater tweezers 10b and 10c, and from 320° C. (lower limit) to 400° C. (upper limit) for the solder sucker 10d. Identifying by the device identifying voltage Vg that a soldering iron, for example, is coupled with the temperature controller, the CPU 50 determines that the range for allowable temperature settings is from 200° C. to 450° C. Thus, if the user intended to set a temperature that is higher than the upper limit of 450° C., the CPU 50 will not accept that setting and will set the temperature at 450° C.

The CPU 50 also recognizes or determines a current temperature of the tip 11a on the basis of the signal from the sensor amplifier 48. In general, the temperature detected by the temperature sensor 25a differs from the current actual temperature of the tip. Accordingly, the CPU determines the current actual temperature of the tip by compensating for the temperature detected by the temperature sensor 25a. The appropriate value or amount of the compensation is pre-determined and memorized for each solder handling device since the appropriate value or amount of the compensation differs with capacity of the heater, heat capacity and other parameter of the tip. The CPU 50 makes the temperature compensation using the compensation value specific to the solder handling device that has been identified as being coupled with the temperature controller 40. In addition, the temperature detected by the thermister is also taken into account. Thus, the compensation of tip temperature is made with high accuracy in accordance with the solder handling device coupled with the temperature controller 40.

From the difference between the set temperature and detected and compensated current temperature, the CPU calculates electric power to be supplied to the heater 50, and instructs the heater control circuit 47 to supply that calculated amount of electric power. The instruction from the CPU 50 to the heater control circuit 47 may be data representing time period during which the electric power is supplied to the heater, and the heater control circuit supplies electric power to the heater for that instructed time period.

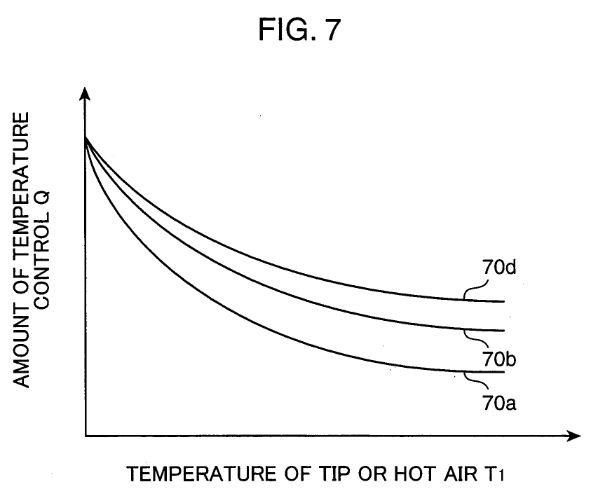

FIG. 7 is a diagram showing the temperature control characteristics set predetermined for respective solder handling devices. The abscissa shows the temperature T1 of the tip or the hot air, while the ordinate shows the amount of temperature control Q which is a parameter of a feedback gain and the like for the heater control circuit 47. The more the amount of the temperature control is, the more the electric power is supplied, provided that the other conditions are the same. FIG. 7 shows the temperature control characteristic 70a for the soldering iron 10a, the temperature control characteristic 70b for the heater tweezer 10b, and the temperature control characteristic 70d for the solder sucker 10d. Those characteristics are predetermined and memorized in a memory device associated with the CPU 50 which in turn selects a temperature control characteristic for the solder handling device 10 that has been identified by the device identifying circuit 42. For example, if the device identifying circuit 42 determines that a soldering iron 10a is connected to the temperature controller 40, the CPU 50 chooses the temperature control characteristic 70a for the soldering iron 10a and makes instruction to the heater control circuit in accordance with that selected characteristic.

Every characteristics shown in FIG. 7 descend to the right such that the lower the temperature T1 of the tip or hot air, the more the electric power is supplied to raise the temperature rapidly. In the region where the temperature T1 is larger, the amount of power supply decreases, thereby avoiding overshoot of the controlled temperature. Although the most appropriated temperature control characteristics are different with the solder handling devices 10, the characteristic is determined and stored for each solder handling device 10, and temperature is controlled with the most appropriate characteristic irrespectively of the type of the solder handling device.

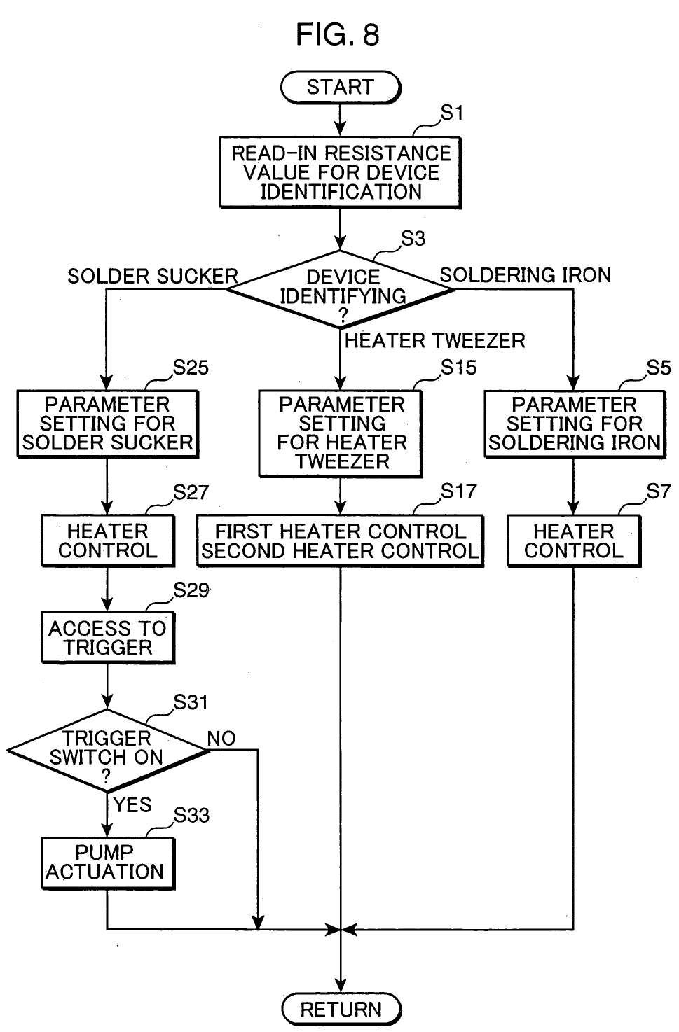

Next, description will be made of the operation of the temperature control system 1 with reference to FIG. 8 which is a flowchart schematically showing the temperature control process performed by the CPU 50. The control flow starts when the power switch is turned on, with any solder handling device being connected with the temperature controller 40. At Step S1, the resistance value of the device identifying resistor is determined from the voltage of the device identifying circuit 42. Then, at Step S3, the type of the solder handling device 10 is identified by the value of the resistance. The flowchart in FIG. 8 shows the control process for three types of the solder handling devices, i.e. the soldering iron 10a, the heater tweezer 10b and the solder sucker 10d, for the simplicity of explanation, but the same or similar process may be applied to other solder handling devices.

If the soldering iron 10a is identified as being connected with the temperature controller 40, the operation of the CPU 50 proceeds to Step S5 where parameters for the control of the soldering iron 10a are set with the characteristic 7a shown in FIG. 7 being selected. Then, the temperature of the heater 23 is controlled in accordance with the characteristic 7a (Step S7).

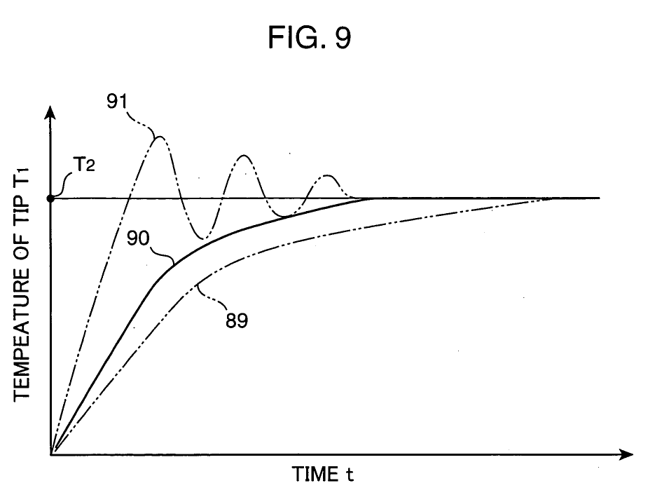

FIG. 9 shows a characteristic of temperature change of the tip 11a at its raising or initial stage of temperature control process carried out as mentioned above. In the diagram shown in FIG. 9, the abscissa shows elapsed time t while the ordinate shows the temperature T1 of the tip 11a. T2 represents a temperature preset by means of the input section 61. As shown by the raising characteristic 90 as indicated by the solid line, the temperature of the tip 11a rises rapidly while the temperature is low, but it rises gently as the temperature approaches the preset value so that the temperature of the tip 11a is raised to the preset value promptly and stably without causing overshooting.

The two-dot chain lines or phantom lines show the temperature control characteristic in two cases where the temperature control characteristic 70a is set improperly. The temperature rising characteristic curve 89 shows the case where the controlled amount of power supply changes at a low level. In this case, as the amount of power supplied is generally too small, it takes too much time for the temperature of the tip to reach the preset value. The temperature rising characteristic curve 91 shows the case where the controlled amount of power supply changes at a high level. In this case, the amount of power supplied is generally so large that the temperature rises rapidly, causing overshooting in which the actual temperature goes beyond the set temperature. After that, the temperature unstably reaches the preset value with the actual temperature oscillating. Thus, the characteristic curves 89 and 91 shows the cases where the temperature control characteristics do not suit the soldering iron 10a. In contrast, according to the embodiment of the present invention, the most appropriate characteristic 70a is selected for the soldering iron 10a, an ideal temperature restoring characteristic is attained.

Returning back to the flowchart of FIG. 8, if it is determined at Step S3 that the heater tweezer 10b is connected to the temperature controller 40, the operation proceeds to Step S15 where parameters for the control of the heater tweezer 10b are set with the characteristic 7b shown in FIG. 7 being selected. Then, at Step S17, the temperatures of the first and second heaters 23b and 24b are controlled in accordance with the characteristic 7b. In this case, the most appropriate temperature control characteristic 7b for the heater tweezer 10b is selected and employed for the temperature control, the temperatures of the tips 11b and 12b are controlled in the manner similar to the temperature raising characteristic 90 shown in FIG. 9.

It is to be noted that the first and second heaters 23b and 24b are controlled separately in accordance with the identification that the heater tweezer is connected with the temperature controller 40. With this separate control, the temperature of either one of the tips 11b and 12b is restored rapidly and smoothly when it changes greatly independently of the other.

If it is determined at Step S3 that the solder sucker 10d is connected to the temperature controller 40, the operation proceeds to Step S25 where parameters for the control of the solder sucker 10d are set with the characteristic 7d shown in FIG. 7 being selected. Then, at Step S27, the temperature of the heater 23d is controlled in accordance with the characteristic 7d. In this case, the temperature of the tip of the nozzle 11d is controlled in the manner similar to that according to the temperature rising characteristic 90 shown in FIG. 9. At Step S31, it is determined if the trigger switch 36 is closed or not. If the closure of the trigger switch is determined, the operation proceed to Step S33 where a vacuum pump (not shown) is actuated to suck reflowed solder.

As an embodiment of the present invention has been described, the present invention is not limited thereto but various changes and modifications are available within the spirit and scope as defined in the accompanying claims.

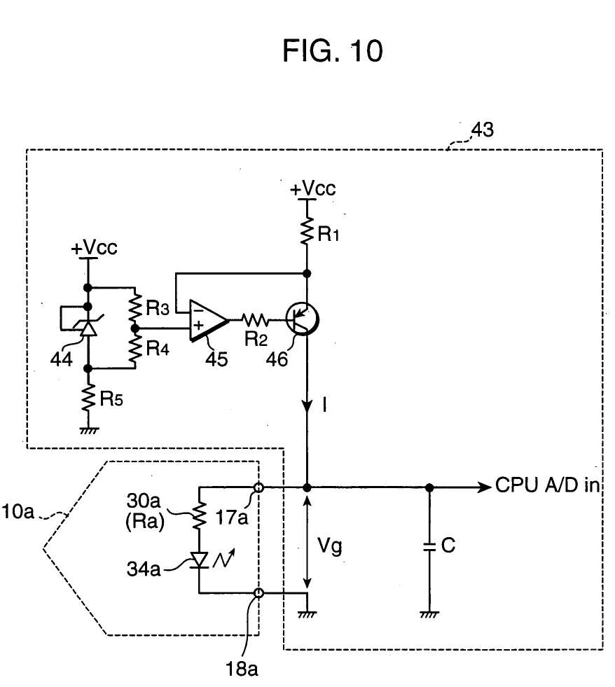

For example, constant current type circuit as shown in FIG. 10 may be employed for the device identifying circuit 43. A constant current circuit includes resistors R1, R2, R3, R4 and R5, a zener diode 44, an amplifier 45 and transistor 46 which are arranged as shown in FIG. 10 to output constant current I from the transistor 46 to the device identifying resistor 30a and the LED 34a. The current I is constant irrespective of the resistance value Ra of the resistor 30a, and is, for example, 0.008A which is proper for the energization of the LED 34a. As the magnitude of the current I does not change even if other solder handling devices are connected to the temperature controller in place of the soldering iron 10a, the LED is energized by the same magnitude of current and emits light of constant brightness. The voltage between the device identifying terminal 17a and the ground terminal 18a, i.e. the device identifying voltage Vg is shown by following the formula (2), wherein the resistance of the LED is out of consideration for simplicity.
Vg=I×Ra (2)

As is apparent from the formula (2), the resistance value Ra is determined by detecting the device identifying voltage Vg by means of the CPU 50 provided in the temperature controller 40, since the electric current I is constant. The resistance value Ra indicates that the soldering iron 10a is connected to the temperature controller 40 as a solder handling device.

As another modification, the device identifying means may be provided in or on the temperature controller 40. For example, the temperature controller 40 may be provided, on its panel, with multiple connectors 41 of a number in accordance with the number of types of solder handling devices to be coupled with the temperature controller 40. Each of the connectors 41 is adapted for connection with a specific solder handling device, such that the CPU identifies the solder handling device in accordance with the connector to which the solder handling device is connected, i.e. by detecting which of the connectors is connected with the device. For example, the CPU 50 determines that the soldering iron 10a is in use, when the connector 14a of the soldering iron 10a is connected to a connector that is specific for the connection with the connector 14a of the soldering iron 10a.

As still another modification, the temperature controller 40 may be provided, on its front panel, with a single connector which has multiple terminals to be selectively connected with connectors of a plurality of solder handling devices in the manner such that each solder handling device has a particular combination of connector terminals to be connected with a corresponding particular combination of terminals of the single connector of the temperature controller 40. With this arrangement, the temperature controller and/or its CPU identify the solder handling device connected thereto by means of the combination of the terminals in use.

In the above described embodiment, the temperature controller 40 is adapted to be selectively coupled with five types of solder handling devices. The number of the types or kinds of the solder handling device 10 may vary in accordance with requisites for the temperature control system 1.

1. A temperature control system, comprising:
a temperature controller and a plurality of solder handling devices which are selectively connected with the temperature controller, wherein
each solder handling device includes a heating member, a heater for heating the heating member and a temperature sensor for detecting temperature of the heating member; and
the temperature controller includes a device identifier for identifying the solder handling device connected thereto, a power supply for supplying electric power to the solder handling device and a power supply control for controlling the supplied power in accordance with the temperature detected by the temperature sensor and the identification of the solder handling device.

2. A temperature control system as claimed in claim 1, wherein the temperature controller includes a temperature control characteristic section for determining a temperature control characteristic for each solder handling device and the power supply is controlled in accordance with the determined temperature control characteristic.

3. A temperature control system as claimed in claim 2, wherein the temperature control characteristic section includes a memory for storing data of temperature control characteristics for solder handling devices to be connected with the temperature controller and a selector for selecting a temperature control characteristic specific to the identified solder handling device in accordance with the identification of the device.

4. A temperature control system as claimed in claim 2, wherein the temperature control characteristic section is adapted to determine a temperature control characteristic that provides a temperature restoring characteristic appropriate to the identified solder handling device.

5. A temperature control system as claimed in claim 1, wherein each solder handling device include an electric component having an electric parameter representative of the solder handling device and the temperature controller includes a parameter detector for detecting the electric parameter.

6. A temperature control system as claimed in claim 5, wherein each solder handling device includes an identifying resistor as the electric component having a resistance value specific to the solder handling device, and the device identifier includes a reference resistor connected in series with the identifying resistor and a constant voltage circuit for applying a constant voltage across a series connection of the reference resistor and identifying resistor such that a voltage across the identifying resistor represents the solder handling device.

7. A temperature control system as claimed in claim 5, wherein each solder handling device includes an identifying resistor as the electric component having a resistance value specific to the solder handling device and the device identifier includes a constant current circuit for supplying constant electric current to the identifying resistor.

8. A temperature control system as claimed in claim 1, wherein the solder handling devices includes a heater tweezer as one of the devices, the heater tweezer including a pair of tips and a pair of temperature sensors for respectively detecting the temperatures of the tips, and the temperature controller is adapted to control temperatures of the tips in accordance with the output of the temperature sensors when the heater tweezer is connected to the temperature controller.

9. A temperature control system as claimed in claim 1, wherein the temperature controller includes:
a limiter for determining a limit for setting of a target temperature, the limit being determined for each solder handling device; and
a preventing section for preventing setting of the target temperature beyond the limit.

10. A temperature control system as claimed in claim 1, wherein the temperature controller includes:
a range setter for setting a range of available target temperature for each solder handling device; and
a refuser for refusing the setting of a target temperature out of the range.

11. A temperature control system as claimed in claim 1, wherein the temperature controller includes a number of controller connectors equivalent with the number of solder handling devices to be connected thereto, and each solder handling device includes a connector which is adapted to be connected with a particular one of the controller connectors, wherein the device identifier is adapted to identify the solder handling device by the controller connector to which the connector of the solder handling device is connected.

12. A temperature control system as claimed in claim 1, wherein each solder handling device includes a connector for the connection of the device with the temperature controller, the connectors of the devices having arrangements of terminals that are different from each other and the temperature controller includes a controller connector adapted to receive all the connectors of the devices, the device identifier is adapted to identify the solder handling device by the arrangements of terminals.

13. A temperature control system comprising:
a temperature controller and a plurality of solder handling devices which are selectively connected with the temperature controller, wherein
each solder handling device includes a heating member or heating medium generator, a heater for heating the heating member or the heating medium and a temperature sensor for detecting temperature of the heating member or the heating medium; and
the temperature controller includes a device identifier for identifying the solder handling device connected thereto, a power supply for supplying electric power to the heater of the solder handling device and a power supply control for controlling the supplied power in accordance with the temperature detected by the temperature sensor and the identification of the solder handling device.

14. A temperature control system as claimed in claim 13, wherein the solder handling devices includes a hot air blower for blowing hot air against electric substrate, and the hot air blower include a fan for blowing a hot air as part of the heating medium generator.

15. A method for controlling temperature of a solder handling device in a system in which a plurality of solder handling devices are selectively connected with a temperature controller which supplies electric power and control temperature of heating member provided on the device or heating medium generated by the device, the method comprising the steps of:
identifying the solder handling device connected to the temperature controller; and
determining a temperature control characteristic to be employed for the control of the temperature of the heating member or medium, the characteristic being determined in accordance with the identified solder handling device.
